(19) United States
(12) Patent Application Publication
(10) Pub. No.: US 2024/0262315 A1
(43) Pub. Date: Aug. 8, 2024

(54) DYNAMIC VEHICLE CONTROL ADJUSTMENT PROVIDING LOSS MITIGATION

(71) Applicant: FORD GLOBAL TECHNOLOGIES, LLC, Dearborn, MI (US)

(72) Inventors: Stuart C. SALTER, White Lake, MI (US); Douglas SMITH, Farmington Hills, MI (US); Trevor FISHER, Windsor (CA); Vijay MALIK, Novi, MI (US); Peter PHUNG, Windsor (CA); David CELINSKE, Wolverine Lake, MI (US)

(21) Appl. No.: 18/163,578

(22) Filed: Feb. 2, 2023

(51) Int. Cl. B60R 25/32; B60R 25/01; B60R 25/102; B60R 25/24; B60R 25/30

(52) U.S. Cl. CPC B60R 25/32; B60R 25/01; B60R 25/102; B60R 25/24; B60R 25/305

(57) ABSTRACT

A vehicle automatically engages a transportation security mode responsive to a vehicle location corresponding to a location predefined for engagement of the security mode. The vehicle also determines that the vehicle has begun movement, and that a characteristic of the movement corresponds to a trigger for a security action designated for the location predefined for engagement of the security mode. The vehicle, based on the movement, characteristic, and location predefined for engagement of the security mode, automatically engages the security action.

### TECHNICAL FIELD

The illustrative embodiments generally relate to dynamic vehicle control adjustment providing loss mitigation.

### BACKGROUND

Vehicles are produced by the thousands at plants and then shipped all over the world via various channels to end-destinations. Since these vehicles are not individually under observation of direct owners until they are sold, they are often housed in large lots at various points during transport. Similarly, during active transport, multiple vehicles may be moved by truck, ship or rail. As vehicles tend to be fairly large objects, keeping a close eye on all the vehicles during the transport process can present challenges.

Due to some of the logistics involved with keeping watch over a large, parked fleet, or a long line of train cars carrying many vehicles, criminals have been emboldened to attempt to obtain vehicles from parking or access the vehicles during transit. Transit access can include stashing objects in vehicle compartments in order to transport illegal goods, or removing valuable components. Lot access can include the same, and in some instances, can also include driving a first vehicle through a fence in order to open a path for additional vehicles to exit improperly. In a massive storage lot, such instances may be difficult to monitor.

Vehicles may also be stored with fobs locked therein, in order to keep the fobs with the corresponding vehicles, but that makes access to the vehicle startup even more possible if a thief can enter the vehicle. Keeping vehicles on a strict lockdown protocol at all times may add significant time and expense to handling when the vehicles are handled by authorized personnel.

### SUMMARY

In a first illustrative embodiment, a vehicle includes one or processors configured to engage a transportation security mode responsive to a vehicle location corresponding to a location predefined for engagement of the security mode and determine that the vehicle has begun movement and that a characteristic of the movement corresponds to a trigger for a security action designated for the location predefined for engagement of the security mode. The one or more processors are further configured to, based on the movement, characteristic and location predefined for engagement of the security mode, automatically engage the security action.

In a second illustrative embodiment, a vehicle includes one or more processors configured to set a transportation security mode responsive to detecting movement of the vehicle while the vehicle is unpowered and set periodic wake events with a first frequency defined by the transportation security mode. The one or more processors are also configured to determine, during a wake state triggered by a wake event of the periodic wake events, determine whether a parameter, defined by the security mode, for increased wake states is me based on current vehicle context, and, responsive to the parameter being met, set an increased second frequency for the periodic wake states.

In a third illustrative embodiment, a vehicle includes one or more processors configured to wirelessly communicate with a group of vehicles being transported together to establish and assign responsibility for group monitoring. The one or more processors are also configured to designate different ones of the group of vehicles to be awake at different predefined times during a transportation journey and place the vehicle in sleep mode when the vehicle is not assigned responsibility based on the designation. Further, the one or more processors are configured to wake the vehicle responsive to a page from a monitoring vehicle assigned responsibility based on the designation and wake the vehicle at one or more of the different predefined times based on the designation of the vehicle as assigned responsibility during the one or more of the different predefined times. While the vehicle is awake, the one or more processors are configured to utilize sensors of the vehicle to detect security breach attempts for both the vehicle and other members of the group of vehicles.

### BRIEF DESCRIPTION OF THE DRAWINGS

FIG. 1 shows an illustrative vehicle transportation chain, vehicle computing system and cloud backend;

FIG. 2 shows an illustrative process for lot mode control;

FIG. 3 shows an illustrative process for mode change;

FIGS. 4A and 4B show illustrative process for wake state modification in transport mode; and

FIG. 5 shows an illustrative process for group monitoring in transport mode.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

While planning a strategy to protect vehicles during transport, it may be worth considering the impact of the measures taken on the daily tasks associated with transporting vehicles. That is, while security systems could run at high alert, vehicles could engage active sensors and theft prevention at all times, and vehicles could remain securely locked at all times, this strategy may place a burden on both authorized humans and vehicle resources.

Authorized human handlers may need to interact with vehicles regularly to move them around in a permissible manner both within lots and from one point to another. Requiring aggressive security checks on each vehicle may significantly slow the operators down, and so during regular business hours, and also perhaps during daylight hours, it may be advisable to relax some security protocols in order to permit authorized interaction with the vehicles more easily, at least in regards to areas where the vehicles are sitting and can more easily by observed by humans and camera systems.

Vehicle resources include fuel and battery levels. Vehicles may sit for a long period of time before being regularly driven by an owner, and overusing power resources, for example, can leave the vehicle power supply depleted. Thus, it may be worth considering strategies that adapt resource usage to increase security at times, locations or under conditions deemed a threat, and to preserve resources at other times. While it is not impossible that an attempt at theft occur under, for example, broad daylight in a secure lot, the likelihood of this may be significantly less than an attempt at theft under bad weather in the middle of the night, when it would be much more difficult to observe. Similarly, a person is much more likely to attempt to access a vehicle on a train when the train is moving slowly through a remote stretch of countryside, than as the train approaches a destination, in a city, moving at 40 miles per hour.

If the power supply of the vehicle can only support active monitoring for a percentage of time relative to total transportation and storage time, this supply can be strategically used to mitigate threat under the most likely instances of theft, and statistically this should yield favorable results.

The illustrative embodiments provide examples of the preceding, allowing for a vehicle to shift into various modes and states within those modes based on current context—which can include, for example, locations, characteristics of locations, time-of-day, weather, proximity to a geo-fence, etc. Because the fleet can be dynamically adapted via pushed information, modifications to mode settings can be broadcast and enabled as conditions change or parameters change.

For example, if crime suddenly rises in a given area, the vehicles housed within the relevant locality can have modifications to their modes and states pushed thereto, allowing for fleet-wide reaction to changing circumstances. In another example, vehicles housed within a lot could be generally set to engage a first state during a time-of-day, and an alternative state at night. If cloud cover or weather created unplanned cover for thieves, the cloud or a lot-computer could push changes to the local fleet. For example, an ambient light sensor could push a state change to the lot if ambient light dropped below a level, and the vehicles could assist in propagating the change through an ad-hoc network. That particular paradigm would relieve some burden on the cloud to monitor all conditions at all relevant locations continually.

Generalized strategies can be adopted to changing real-time conditions in this manner. For example, vehicles traveling on a train may have a first level of security state engaged, but if the train unexpectedly slows, or if a break-in is detected by a given vehicle, security upgrades can be swiftly propagated to the entire load of vehicles to put them on alert. Vehicles traveling in packs like this can also use shared load balancing for security purposes, with different vehicles using their power supply for the benefit of the group and acting as active monitors, passing responsibility in a manner that continues to maintain relative constant power resources for the vehicles involved, as needed. Such systems may also account for the remaining power needs of a vehicle before planned arrival at a dealership—e.g., a vehicle nearing the end of the transportation journey can assume a more active role, having less need for longer power preservation than vehicle that still has days before it reaches a final destination.

By using resources strategically and under context, the overall protection of the fleet can be advanced in a manner that deliberately deploys power resources as needed in furtherance of a model that can reduce the overall likelihood of theft. At the same time, by not overusing resources, vehicles will be less likely to reach depleted states, maintaining their ability to function as needed throughout the transportation process. And, accommodation can be made for authorized access and usage, to maintain efficiency of process with regards to shipping and handling.

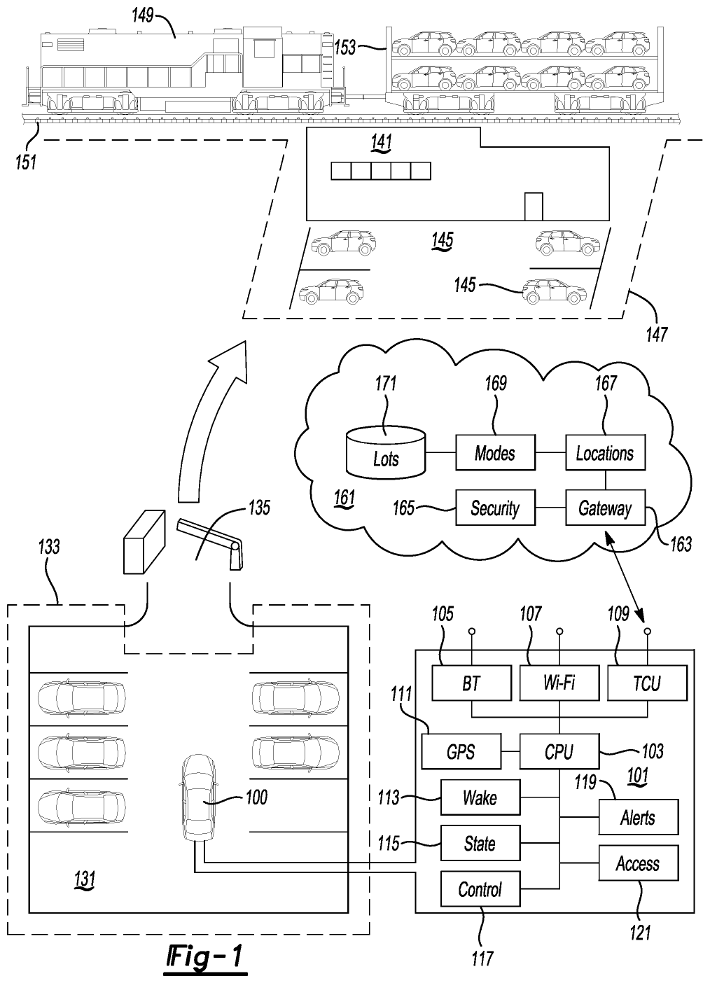

FIG. 1 shows an illustrative vehicle transportation chain, vehicle computing system and cloud backend. In this example, some number of vehicles, including vehicle 100, may be stored in a lot 131 post-production or during transportation. Each vehicle 100 may include an onboard computing system 101, which can include one or more communication channels.

In the example provided, the communication channels include use of a BLUETOOTH transceiver 105, a Wi-Fi transceiver 107 and a telematics control unit 109. The BLUETOOTH or Wi-Fi transceivers can be used for local communication on the lot or while in transport, allowing for vehicle to vehicle (V2V) communication. As noted above, this can allow for pushing of changes to security protocols through ad-hoc networking, and can allow one or more designated vehicles to serve as group-monitors, in a rotating fashion if desired. This model can also allow for less-equipped vehicles to benefit from better-equipped vehicles in terms of sensing and threat detection. Vehicles most capable of threat detection can serve primary roles in group monitoring if desired, and thus not every vehicle need have the same level of sensing and alert capability, assuming the better equipped vehicles have sufficient power to monitor the group. Vehicles with lesser sensing can be tasked with group monitoring at lower threat or other appropriate instances, so that power in the better equipped vehicles can be preserved for monitoring under higher threat conditions.

In this example, the lot 131 is fenced by a geo-fence 133, which has a change indicting where the proper lot exit 135 occurs. This geofence can be known by all vehicles, and based on proximity to the fence and/or heading, for example, characteristics of available vehicle control can be changed.

For example, it may be the case that the exit 135 is always monitored, and thus represents an unsuitable escape route for thieves. In that instance, when a vehicle attempts to approach the fence-line in a non-exit area, the proximity to the geofence can reduce maximum vehicle speeds to, for example, a few miles an hour. That would still allow for authorized maneuvering, but would also prevent high-speed penetration of the fence. Speed could be dropped to 0 miles per hour and the vehicle disabled, if it actually crossed the fence 133 in a region not adjacent to the proper exit. If all vehicles acted in this manner, then it would be nearly impossible to even create a hole in the fence using a vehicle, let alone drive vehicles off of the lot through a hole created using another vehicle. Knowing that this sort of behavior was used by the vehicles in storage would also eventually diminish attempts to steal vehicles in this manner.

If the vehicle passes through region 135, which could also include an “enabling” geo-fence enabling certain controls, then the vehicle could function as appropriate. For example, a vehicle passing through the region, but without being powered, is likely on a transport. That vehicle could engage a transport mode suitable for protecting the vehicle during transportation on a truck. Another vehicle may be permissibly drive through the region, and if the gate is, for example, correctly engaged and lifted, this could pass a control signal to the vehicle to enable full control, via a lot-computer. Or a vehicle camera could see the gate arm lift and responsively permit full control, in conjunction with the present location, as another example. Attempts to leverage knowledge of these protocols (e.g., forcing a gate lift) could be recognized and the paradigms for full control could be changed dynamically through pushed instructions to a fleet or portion of a fleet. That way, thieves may never know what particular protocols or adaptations are in place.

In other examples, the gated area may not be monitored during certain hours, and in those instances the region adjacent area 135 can behave as the other fence-external regions of geo-fence 133—i.e., any engine or speed control changes, or other changes, can similarly be applied when a vehicle approaches exit 135 at a time when the exit is not monitored. Basic sensing can even engage such protocols on a limited basis when, for example, a security guard goes on a lunch break or uses the restroom—a sensor not sensing the presence of the guard could engage the security automatically, and/or the guard could expressly change the applicable security paradigm based on intended absence for some period of time. These changes can be quickly propagated through V2V ad-hoc networking and all vehicles in the lot can adapt to the change in circumstances.

The vehicle TCU 109 may communicate with the cloud for updates to security instructions and changes to modes based on cloud-observed changing conditions. These changes can be instituted onboard the vehicle via a control changing module 117. An onboard state monitoring module 115 can determine a current state (e.g., parked, moving under power, moving but unpowered, etc.). which may be applicable in determining which mode to apply. Vehicles under certain conditions may sleep for periods of time, and a dynamic wake module 113 can be used to wake the vehicle periodically to determine if a situation has occurred or is occurring. This wake state can be varied based on the current state—e.g., a vehicle parked in a secure lot may wake more infrequently than a vehicle being transported. Moreover, certain paging commands can cause the vehicle to wake as well, allowing for pushing updates to a current security plan even while a vehicle is sleeping.

The vehicle may also include alert module 119. This module can react to an undesirable circumstance by issuing notifications to the cloud, sounding an alarm, flashing vehicle lights, engaging external speakers, engaging interior video recording, etc.

An access module 121 may dynamically control access credentials based on context, dictating when certain codes or other credentials, such as facial recognition or an NFC card, may need to be used to access a vehicle. This or a comparable module can disable the use of the key fob as needed, so that the fobs can be left in the vehicles without fear of them being used to start the vehicle if a window is broken or the vehicle is otherwise accessed.

As the vehicle is moved, permissibly, from the lot 131 to another point in the journey, such as train station loading lot 143, the vehicle 100 can responsively change modes and settings within modes based on a current state of travel. For example, while on a car carrier being driven to the station lot 143, the vehicle may engage a higher level of security during travel on roads at speeds under 35 miles per hour, and a lower level of security on highway travel, for example, where theft may be difficult. This mode change can occur automatically based on the GPS 111 reporting coordinates to the vehicle control process 117, corresponding to speed and travel, or the cloud 161 can track vehicle location and instruct mode setting based on current conditions corresponding to the current location.

As the vehicle reaches the lot 143 and breaches a geofence 147, lot-control modes for the train storage lots can be responsively engaged, for example, if the storage lot is under constant observation and is relatively small in size, the security protocols may be relaxed to preserve power. Further, the geo-fence 147 can extend some distance down the train tracks 151 in each direction, so that vehicles arriving by truck or rail can have a similar reaction to reaching the increased-security domain of the lot 143. At the same time, any vehicle exiting the fence may engage enhanced or altered security protocols based on which exit is use and whether the vehicle is driven off, carried off by truck or carried off by train 149. In other examples, vehicles 153 loaded onto train 149 may be set to different settings from lot 143, wherein vehicles 145 are easier to observe. This can help prevent opportunistic thieves from taking advantage of loaded trains that have not yet left the rail yard, but which may be clustered in a manner that makes complete observation of the vehicles and areas adjacent the trains difficult due to visual obstruction.

The cloud 161 may include a gateway for request and response routing, which in this example can include reporting on vehicle states, reporting on any thefts or alerts, and state change instructions or paradigm modifications based on observed or reported data.

The cloud may for example, include a locations analysis process 167 that can both determine a current mode to be applied based on location (e.g., lot vs. transportation) as reported by a vehicle 100, or can determine, for example, what context variables are present at a location, such as slowdowns in transportation, traffic, track-impediments, weather, ambient light conditions, increase in theft or threat, etc. This process can work in conjunction with a mode setting process 169 that can both instruct mode institution in a vehicle or fleet set, or, for example, modify mode settings to adapt to a changed circumstance at the current location of one or more vehicles 100.

A lots dataset 171 can also include other context data, such as track locations, route locations, etc. This can be used to track current variables in context as well, such as weather at the respective lots or other locations and any other relevant conditions.

A security function can respond to threats indicated by one or more vehicles 100, which can include contacting authorities and pushing mode changes or paging vehicles to wake responsive to an active threat.

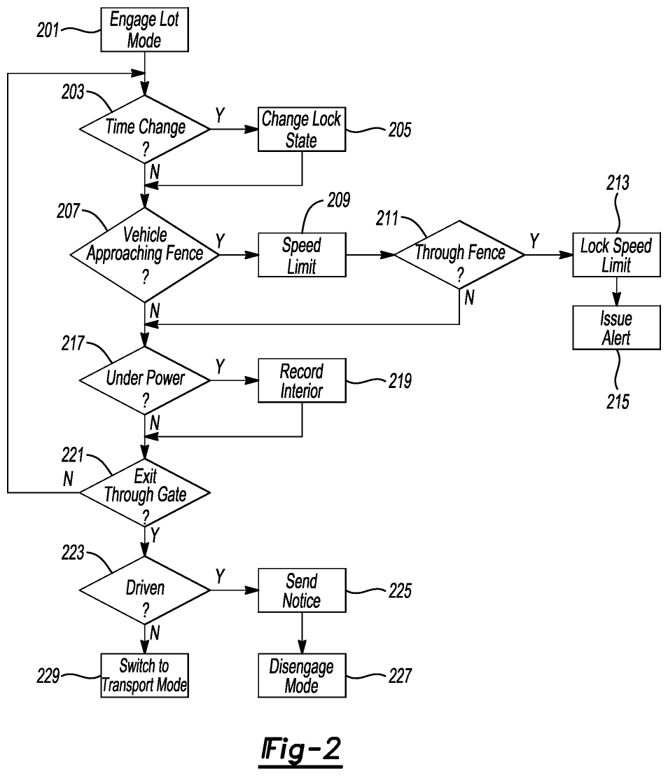

FIG. 2 shows an illustrative process for lot mode control. In this example, the process engages a lot mode at 201. Engagement can be a reaction by the vehicle to determining that the coordinates are within a known lot, or can be engaged, for example, by an active vehicle crossing into a geofence lot perimeter. Vehicles can also be expressly instructed into a particular mode, by, for example, a driver, a lot-computer, the cloud, etc.

In this example, vehicles will enter an unlocked state during designated working hours on working days, so the process determines if a time change (either to or from working hours) has occurred at 203 and, if the change has occurred, responsively changes the lock state at 205. This can include, for example, changing from an unlocked to lock state outside of working hours, or vice versa. Changing to a given state may also enable or disable use of fobs, for example, as determined to be appropriate for a given location or model. When a fob is disabled, the vehicle may require a code, an NFC scan, facial recognition or some other credential in order to be operated.

Another consideration in this example is whether a vehicle is approaching a fence at 207. Since a vehicle will be powered if being drive towards a fence, and since a vehicle may need to be powered to be loaded onto a carrier, most circumstances that lead to a fence-approach will occur in a woken vehicle. If desired, although not necessary, the fence can also include short-range beacons that will wake a vehicle via paging if the vehicle comes within range. This may be useful if vehicles will get loaded onto a carrier but sit within a lot long enough to return to sleep state.

If the vehicle 100 is approaching the fence at 207, the process may begin to limit the speed of the vehicle at 209, in some manner inverse to proximity to the fence. That is, the closer the vehicle gets to the fence, the lower maximum achievable speed. Speeds can be restricted down to low single digits, although typically the speeds will still remain above a threshold unless the vehicle crosses the fence, to account for the potential inaccuracy of GPS and the fact that vehicles may need to be permissibly moved in proximity to a geofence. At the same time, the geofence may be set at a distance where GPS error does not regularly trigger a crossing event, so that if the geofence is actually crossed by a vehicle in any but a permissible location at 211, the process locks in a speed limiting lock at 213 (which can include stopping the vehicle entirely) and alerts the appropriate parties at 215.

Because beacons and other systems can be used for refining GPS coordinates, it may be possible to set the geofence relatively close to an actual lot edge. For example, any vehicle triggered as “crossing” a fence could immediately communicate with surrounding vehicles at short ranges and/or use camera feeds to determine if it was actually leaving the lot. This can occur before permanently locking the control state to ensure the lock is justified. Locked control states may also be undone by a simple code or NFC input, so it may be the case that inadvertent locking of vehicle states to low or no speed can be undone easily enough that it does not present a material problem for authorized operators if it occurs periodically due to GPS error. It is also possible to simply move the fence back from the lot some distance by pushing an update, since the fence is a digital construct that requires no construction to move. So, if false positives are too frequent based on locality, for example, the lot-computer or cloud can simply move the fence out away from the lot a number of feet until the level of false positives stabilizes at an acceptable level.

The process here also checks if the vehicle is under power. Vehicles can move while not under power by being transported, and typically transport off a lot in this manner is authorized. This is because it may be very difficult to load and exit with a car carrier without being noticed. If the vehicle is being powered and driven on the lot at 217, the vehicle may record, continually or at intervals the interior of the vehicle using vehicle cameras. This keeps a record in case the driver is unauthorized.

The process also determines if the vehicle is exiting through a gate or authorized access point at 221. If not, then the monitoring and lot mode continues, checking for the preceding and comparable situations representative of potential threat. If the vehicle is exiting through a designated exit at 221, the process determines if it is driven at 223 (as opposed to being carried). If the vehicle is driven, the process may assume the exit was permissible, since it occurred through a gate, unless there are gate variables associated that are not met. This can include, for example, time of day, a signal from a gate computer, or a vehicle camera observing a gate arm lifting.

The process sends a notice to the cloud and any other monitoring entity that the vehicle has exited the lot at 225, as a precautionary backup, and then disables the lot mode allowing the vehicle to be driven at normal speeds at 227. The vehicle can always be reverted to a control-restricting mode if the alert message triggers an actual alert and the vehicle was not supposed to be driven off. If the vehicle is not being driven at 223, then the vehicle 100 can set a carrier transport mode at 229, corresponding to context and a mode of transport.

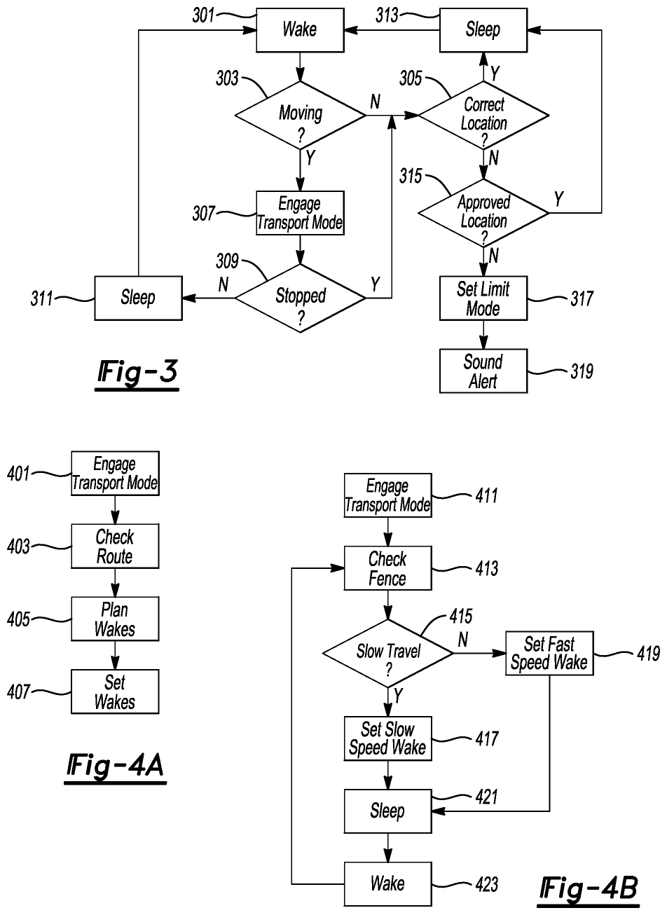

FIG. 3 shows an illustrative process for mode change. In this example, the vehicle wakes periodically or in response to a page at 301, from a sleep state that preserves power. The wake period can be dynamically adjusted based on context-for example, the vehicle may wake more frequently when being transported (than when parked in a lot), and even more frequently when the transportation is slow or remote enough to encourage threat.

At the same time, it may not always be practical to keep the vehicle continually awake, and so a transport mode may shift while the vehicle remains in sleep mode. Accordingly, the vehicle 100 can determine, upon waking, if a mode shift is required or instructed.

For example, if the vehicle determines it is presently moving (which in this case would be a transport, since the vehicle would already be awake if being driven) at 303, the vehicle may engage a transport mode according to the form of current transportation at 307. Based on whether GPS coordinates correspond to a road (as opposed to train tracks or water), the vehicle may determine the mode of transport. Modes of transport may also be determined by movement indicative of a truck, train or ship. Movement can be determined based on accelerometers or changing GPS coordinates.

If the vehicle is not stopped in motion while awake at 309, it may return to sleep, having switched to the correct transport mode. Switching to a transport mode may increase the wake cycle as well, to more frequent waking, if the mode of transport or path of transport includes increased likelihood or possibility of threat.

If the vehicle does stop while awake at 309, the process can check a current location at 305. This is comparable to a location check that can occur if the vehicle is not moving when it wakes, although the predicate for alarm may vary based on circumstance. If the vehicle wakes and is in a different location than when it went to sleep, it may want to determine if that location is a proper location on a planned route. Since the vehicle is not (or was not) just moving, that location is likely a lot and the vehicle can determine if it is actually in a lot or authorized area or if it has been moved to somewhere impermissible at 315.

If the vehicle switched from a move to stop state, the location check at 309 can determine if the stop is one that corresponds to a stop suitable for the mode of transport, such as a red light, a train station, a shipping yard, etc. Again, even if not a final destination, the stopped location corresponds to an expected stop and so gives little cause for alarm. If the location corresponds to a permissible one at 315, the vehicle 100 can return to sleep, making any mode adjustments as needed for future wake states based on a context of the stop—e.g., not changing a mode if the stop is at a light and transport will continue, changing to a lot mode if the stop is at a train station where the vehicle is to be offloaded to a lot, etc.

If the location is not a permissible or expected location at 315, the vehicle can immediately engage a control limiting mode at 317 and send an alert to appropriate parties at 319, using vehicle communication systems.

FIGS. 4A and 4B show illustrative process for wake state modification in transport mode. In FIG. 4A, the vehicle engages a transportation mode at 401 and then checks a planned route for the vehicle at 403. This is assuming the vehicle (or the cloud) has knowledge of a planned route for transport of the vehicle. The route can include train travel as well as other forms of travel, as the idea here is to plan wake state settings based on knowledge of areas of higher threat along a route. This can include transportation through high theft areas, as well as slow transportation through remote areas where theft may be encouraged.

The process plans a wake strategy at 405, which can include, for example, planning a wake state just prior to entering an area of increased threat so that the vehicle can be woken for a mode shift and increase in wake states, after confirming that the area has been reached or is proximate. Corresponding wake states can then be set, based on, for example, time intervals. Time intervals can also be adjusted at subsequent wake states if the vehicle is moving slower or faster than expected towards a mode-change locality.

In FIG. 4B, the process also engages a transportation mode at 411, and checks whether the vehicle is within a geofence indicating slow planned travel at 413. As an alternative to route tracking, the vehicle may utilize predefined geofences around areas of slow transportation, where transportation may commonly move at a speed that would encourage a more frequent wake state to prevent theft. If the vehicle is within such a fence at 415, the process may set the wake states to more frequent occurrence at 417. If the vehicle is not in such a region, and, for example, if current speed is not lower than expected outside the slower regions, the vehicle may set a longer sleep duration between wakes at 419.

Since the vehicle, in this example, can adapt to fixed fences based on present location, no real planning or knowledge of a route is necessary to continually adjust wake cycles based on present mode of transportation. Each time the vehicle wakes, it can set the next wake cycle based on its current context. Once the cycle has been set, the vehicle may return to sleep mode at 421.

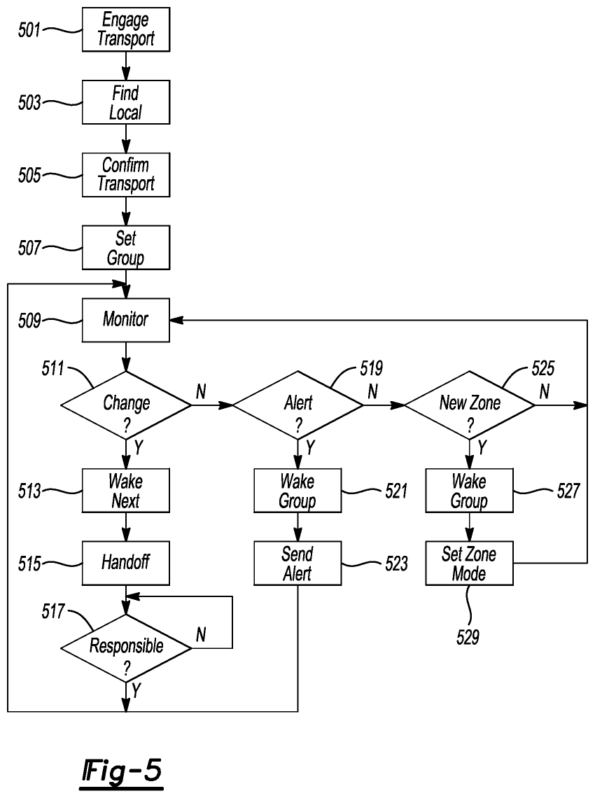

FIG. 5 shows an illustrative process for group monitoring in transport mode. In this example, vehicles moving together will work in concert to monitor each other, with one or more designated vehicles being awake when needed, to provide for more continual monitoring without overtaxing the resources of a given vehicle. Vehicles can dynamically coordinate with proximate vehicles (such as those on a same train or carrier) to form a monitoring group, and responsibility for monitoring can be handed off as needed.

Vehicles that are awake can page other vehicles to wake them, and this can allow for more reactive mode shifts responsive to context, since at least one vehicle is more likely to be awake and aware of a context shift.

In this example, the vehicle engages a transport mode at 501, although a similar model could be used for lot monitoring, with vehicles dynamically entering and exiting the group as they are cycled through a lot.

The process attempts to find at least a certain number of local vehicles at 503, designated as useful for group monitoring, and to ensure the vehicle is not being transported singularly. These can be one or more hops away on an ad-hoc network, although vehicles more than N hops away may be designated to another group. Two groups can coordinate membership to appropriately load balance and to leave each group with sufficient resources (in terms of power and sensors, for example) to facilitate load sharing.

Once a sufficient number of group vehicles have been found at 503 and transportation has been confirmed at 505 (e.g., through exitance of a yard geofence), the process can set the group at 507, which may remain a group until either power reserves run low, preventing group assistance, or members of the group change, or the transport reaches a destination.

One or more designated group members acts as a monitor at a given time at 509, which can be continual or at shorter intervals than vehicles may be able to efficiently self-monitor. Monitoring vehicles may have designated changeover points related to, for example, time spent monitoring, power remaining, power spent monitoring, coordinates, etc. If a change point does not occur at 511, then the designated vehicle continues monitoring to check for several reasons to wake the group.

In this example, those include an alert state at 519 and/or a new zone state or changed context at 525. The alert state can be triggered by use of vehicle sensors to detect attempted theft. Machine learning models can analyze observed behavior and correlate that to expectations based on context to determine if observed behavior rises to the level of a threat (e.g., someone observed running alongside a slow-moving train).

If there is an alert at 519, the process can wake the group or members of the group at 521 and send an alert to each, as well as the cloud at 523. The waking of the group under this context can cause the group to engage in group sensing, group alarm, etc. The monitoring vehicle can also direct the members of the group to the proximate locality where the behavior or threat was observed, to better leverage the sensing capability of the group. For example, all vehicle cameras having views of the area and adjacent areas may be engaged to better track a perceived threat.

If there is no alert, there may instead be a context change at 525. This can include breaching a geofence that indicates a new mode to be set, or a change in travel state, ambient light, weather, speed, etc. These may be reasons to increase group wakefulness in general, and so the monitoring vehicle may wake the group at 527 so that group members may adjust their personal wake routines at 529.

This may also be triggered during increased monitoring, wherein a given vehicle's resources are taxed more than expected and so handoffs may need to be replanned. The monitoring vehicle can devise a new sharing strategy based on observed resource usage and wake the group to implement the new strategy. A new strategy, mode or wake state may be set at 529.

If the change point or change condition has been reached at 511, the process may wake a designated next one or more vehicles at 513 so they can take over control of the monitoring. The process can hand off any observed context at this point at 515, as well as hand over any credentials necessary to effectively page and wake the group. If the responsibility of the prior monitoring vehicle continues at this point at 517, it can continue monitoring. Otherwise, it can then enter a sleep state since monitoring has been handed off to other vehicles in the group.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or processors configured to:
engage a transportation security mode responsive to a vehicle location corresponding to a location predefined for engagement of the security mode;
determine that the vehicle has begun movement and that a characteristic of the movement corresponds to a trigger for a security action designated for the location predefined for engagement of the security mode; and
based on the movement, characteristic and location predefined for engagement of the security mode, automatically engage the security action.

2. The vehicle of claim 1, wherein the engagement of the transportation security mode is further responsive to a vehicle having an assigned digital state designation for post-production transportation.

3. The vehicle of claim 1, wherein the characteristic includes movement under the vehicle's own power and the security action includes recording an interior of the vehicle with a camera of the vehicle at least while the vehicle remains within a boundary associated with the location predefined for engagement of the security mode.

4. The vehicle of claim 1, wherein the characteristic includes movement under carried-transportation without the vehicle being powered and wherein the security action includes issuing an alert responsive to the vehicle exiting a boundary associated with the location predefined for engagement of the security mode at a point along the boundary other than a predesignated exit point.

5. The vehicle of claim 1, wherein the characteristic includes movement under the vehicle's own power and the security action includes automatically limiting a maximum speed of the vehicle as the vehicle approaches a boundary associated with the location predefined for engagement of the security mode at a point along the boundary other than a predesignated exit point.

6. The vehicle of claim 5, wherein the maximum speed is inverse to proximity to the boundary, such that the maximum speed decreases as proximity to the boundary at the point along the boundary, other than the predesignated exit point, increases.

7. The vehicle of claim 6, wherein the maximum speed is set to zero and the vehicle is automatically stopped from movement if the vehicle breaches the boundary at the point along the boundary other than the predesignated exit point.

8. The vehicle of claim 1, wherein the one or more processors are further configured to:
determine that a current time of day corresponds to a locked or unlocked vehicle state, designated by the transportation security mode for the current time of day; and
maintain a lock state of the vehicle to the locked or unlocked state based on the designation and the current time of day.

9. A vehicle comprising:
one or more processors configured to:
set a transportation security mode responsive to detecting movement of the vehicle while the vehicle is unpowered;
set periodic wake events with a first frequency defined by the transportation security mode;
determine, during a wake state triggered by a wake event of the periodic wake events, determine whether a parameter, defined by the security mode, for increased wake states is me based on current vehicle context; and
responsive to the parameter being met, set an increased second frequency for the periodic wake states.

10. The vehicle of claim 9, wherein the context includes the vehicle determining that movement is occurring below a predefined threshold speed, defined by the transportation security mode.

11. The vehicle of claim 10, wherein speed of movement of the vehicle is determined based on consecutive GPS coordinate readings.

12. The vehicle of claim 9, wherein the context includes the vehicle determining that the vehicle is located within an area for which increased frequency wake events is predefined.

13. The vehicle of claim 12, wherein the vehicle location is determined based on vehicle GPS coordinates.

14. The vehicle of claim 12, wherein the vehicle location is determined based on communication between the vehicle and an infrastructure transceiver.

15. A vehicle comprising:
one or more processors configured to:
wirelessly communicate with a group of vehicles being transported together to establish and assign responsibility for group monitoring;
designate different ones of the group of vehicles to be awake at different predefined times during a transportation journey;
place the vehicle in sleep mode when the vehicle is not assigned responsibility based on the designation;
wake the vehicle responsive to a page from a monitoring vehicle assigned responsibility based on the designation; and
wake the vehicle at one or more of the different predefined times based on the designation of the vehicle as assigned responsibility during the one or more of the different predefined times, wherein, while the vehicle is awake, the one or more processors are configured to utilize sensors of the vehicle to detect security breach attempts for both the vehicle and other members of the group of vehicles.

16. The vehicle of claim 15, wherein the designation is based at least in part on vehicle sensor capability.

17. The vehicle of claim 16, wherein at least one vehicle of the group having at least one type of predefined sensor is awake during each of the different ones of the predefined times based on the designation.

18. The vehicle of claim 16, wherein the designation is based at least in part on vehicle power reserves remaining to each vehicle of the group and is determined to leave at least a threshold amount of power remaining in each vehicle of the group.

19. The vehicle of claim 15, wherein, while the vehicle is awake and when the vehicle is awakened responsive to the page from the monitoring vehicle, the one or more processors are further configured to utilize sensors of the vehicle under at least partial instruction from the monitoring vehicle.

20. The vehicle of claim 15, wherein, while the vehicle is awake, the one or more processors are further configured to determine that a power reserve has fallen below a predetermined threshold and pre-emptively wake a designated next vehicle, via a page, for monitoring, prior to a time for the next vehicle to begin monitoring originally designated by the designation.
